(19) United States
(12) Patent Application Publication
(10) Pub. No.: US 2015/0112799 A1
(43) Pub. Date: Apr. 23, 2015

(54) METHOD AND SYSTEM FOR OFFERING PERSONALIZED FLASH SALES EXPERIENCE TO A USER

(71) Applicant: Gilt Groupe, Inc., New York, NY (US)

(72) Inventors: Erik D. LUMER, Brooklyn, NY (US); Jonatan G. KIDON, Brooklyn, NY (US)

(73) Assignee: Gilt Groupe, Inc., New York, NY (US)

(21) Appl. No.: 14/056,075

(22) Filed: Oct. 17, 2013

(51) Int. Cl. G06Q 30/00

(52) U.S. Cl. CPC G06Q 30/00
USPC 705/14.53

(57) ABSTRACT

A method, system and computer program are configured to provide a personal flash sale experience for a user. The method, system and computer program involve maintaining a plurality of flash sales of items including inactive flash sales and flash sales to be broadcasted to a plurality of users, selecting for a user one or more inactive flash sales from the plurality of flash sales of items according to a user's exposure level to items, sales performance of items and/or user's preferences, activating the selected one or more flash sales, and providing to a user a combination of flash sales including the broadcasted flash sales and the selected one or more flash sales.

### BACKGROUND

I. Field

The present disclosure relates to the field of flash sales, and more particularly, to an approach for providing a personal flash sale experience to a user.

II. Background

With advancements in technology, such as in the area of the Internet and mobile computing, many consumers are now attending to their shopping needs online through their computer, and mobile or portable devices. A whole online industry has arisen to capture this consumer market, including “deal” sites operated by online merchants that broadcast product offerings to consumers at a significant discount but often under restricted conditions, such as limitations as to time and/or quantity. However, a consumer may have little or no interest in many of the broadcast product offerings from an online merchant, which are typically aimed at a general audience of consumers.

### SUMMARY

In accordance with a disclosed embodiment of the present disclosure, a method, system and a computer program provide a personal flash sale experience. The method, system and computer program involve maintaining a plurality of flash sales of items including inactive flash sales and flash sales to be broadcasted to a plurality of users, selecting for a user one or more inactive flash sales from the plurality of flash sales of items according to a user's exposure level to items, activating the selected one or more flash sales, and providing to a user a combination of flash sales including the broadcasted flash sales and the selected one or more flash sales. Other parameters may also be used in the selection process, such as a sales history of an item and/or the user's preferences.

The method, system and computer program may also involve tracking or determining an exposure level to one or more items by the user. The exposure level of the user to an item can depend on various factors, such as a number of times the item was previously offered for sale to the user or a number of times the item was browsed by the user.

The selected one or more flash sales can include one or more personal flash sales of items for the user. For example, one or more items available for sale may be selected according to preferences of the user (also referred to as the “user's preferences”). Each of the selected one or more items is scored according to the preferences of the user, and one or more items are filtered out from the selected one or more items according to their scores. One or more personal flash sales are automatically generated with the remaining selected item(s). The one or more inactive flash sales of items can be selected according to an exposure level to the items by the user and at least one of a sales history of an item or a user preference.

The method, system and computer program may also involve updating a personal list of activated flash sales for the user to include the activated, selected one or more flash sales. The personal list of activated flash sales may be updated for the user to remove expired flash sales. Furthermore, activated flash sales may be retrieved and provided to the user from the personal list of activated flash sales in response to detection of a logon by the user.

### BRIEF DESCRIPTION OF THE DRAWINGS

The description of the various exemplary embodiments is explained in conjunction with the appended drawings, in which:

FIG. 1 is a block diagram of an exemplary system environment in accordance with one disclosed embodiment.

FIG. 2 is an overview of an exemplary process flow for providing flash sales, including broadcast and non-broadcast flash sales, to a user in accordance with a disclosed embodiment.

FIG. 3 is a flow diagram of an exemplary process of providing a personal flash sale experience to a user in accordance with a disclosed embodiment.

FIG. 4 is a flow diagram of an exemplary process of automatically generating a personal flash sale for a user, in accordance with a disclosed embodiment.

FIG. 5 is a flow diagram of an exemplary process of automatically generating a personal flash sale for a user in accordance with a further disclosed embodiment.

FIGS. 6 and 7 are screenshots of exemplary interfaces through which a user is provided a listing of flash sale categories and flash sales of items in a particular category in accordance with a disclosed embodiment.

FIG. 8 is an exemplary profile data for a user in accordance with an embodiment.

FIG. 9 is an exemplary item data for one or more item in accordance with an embodiment.

FIG. 10 is a block diagram of exemplary components of a user device or computer system in accordance with an embodiment.

FIG. 11 is a block diagram of exemplary components of a server or computer system in accordance with an embodiment.

### DETAILED DESCRIPTION

In accordance with various disclosed embodiments, there is provided a method, system and computer program for providing a user with a personal flash sale experience. In various exemplary embodiments, a flash sale of an item is selected for a user from a plurality of flash sales of items according to the user's exposure level to the item. Other parameters may also be used in the selection process, such as a sales history of an item and the user's preferences. The selected flash sale is activated for the user and provided along with broadcast flash sales to the user. Accordingly, a user is provided with a personalized selection or recommendation of flash sales, which may be of interest to the user.

An item, as discussed herein, includes a good and/or service. For example, a good can include: wearable goods such as clothes, glasses, jewelry, watches, shoes and other accessories; home goods such as furniture, lamps, art work, window treatment, rugs and bedding; tickets such as a ticket for transportation or an event; or other types of goods. A service can include physical therapy, spa treatments, pet care or other services. The above-identified goods and services are simply provided as non-limiting examples.

A flash sale of an item, as discussed herein, is an offer for sale of an item, which is restricted or limited at least by a time condition (e.g., one hour, 12 hours, 1 day, a specific date and time, etc.). A flash sale may be further restricted by other conditions, such as a quantity of the item.

An exemplary system environment, processes and databases are described below in further detail.

### A. System Environment

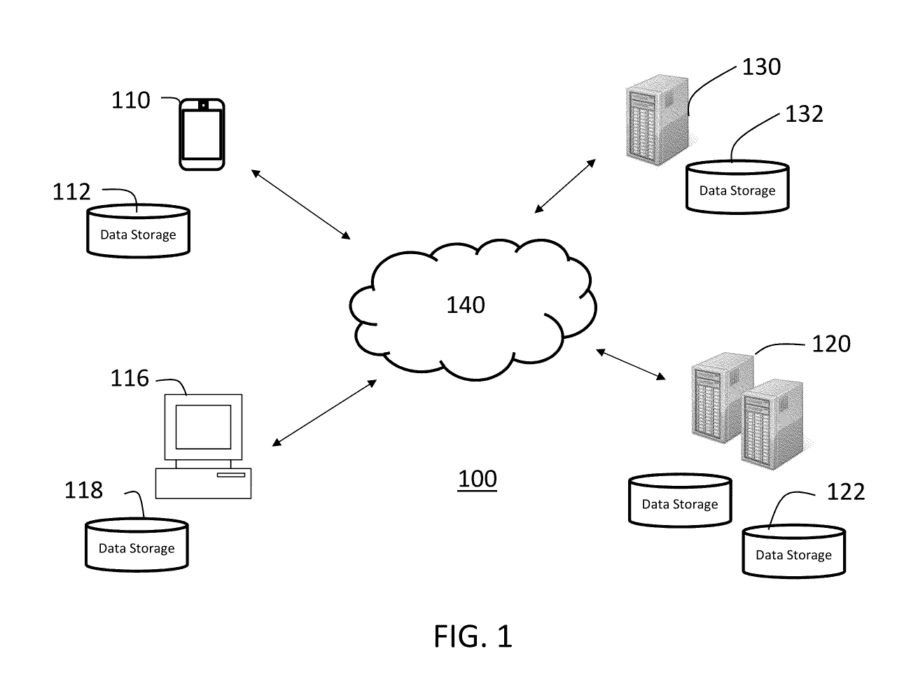

FIG. 1 illustrates a block diagram of an exemplary system environment 100 for providing a user with a personal flash sale experience. As shown in FIG. 1, the system environment 100 includes one or more user devices 110 and 116, such as a computer (e.g., personal computer, a computer terminal, and a kiosk, etc.) and a portable or mobile computing device (e.g., a smartphone, a tablet computer, and a laptop computer). The user devices 110 and 116 also include data storage devices 112 and 118.

The system environment 100 also includes an item transaction system implemented through a server(s) 120 (e.g., a web server) and one or more data storage devices, such as data storage device 122. The item transaction system facilitates the offer and sale of items to a user through the user devices 110 and 116. Data storage of information can also be provided remotely through a remote data storage system (e.g., a remote or cloud storage) implemented through a data server 130 and data storage device 132.

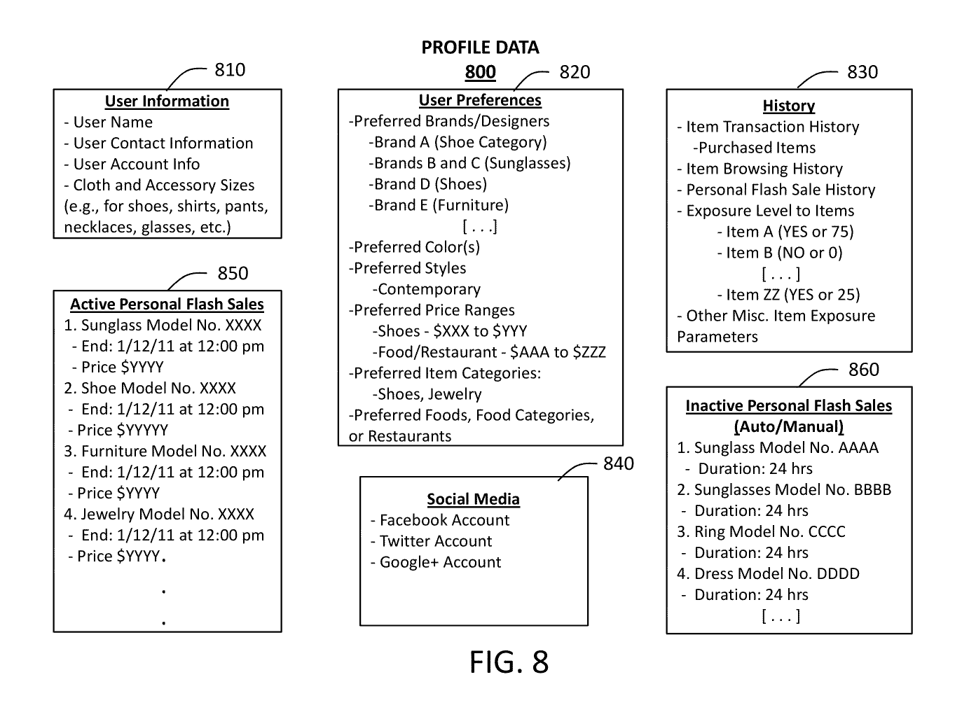

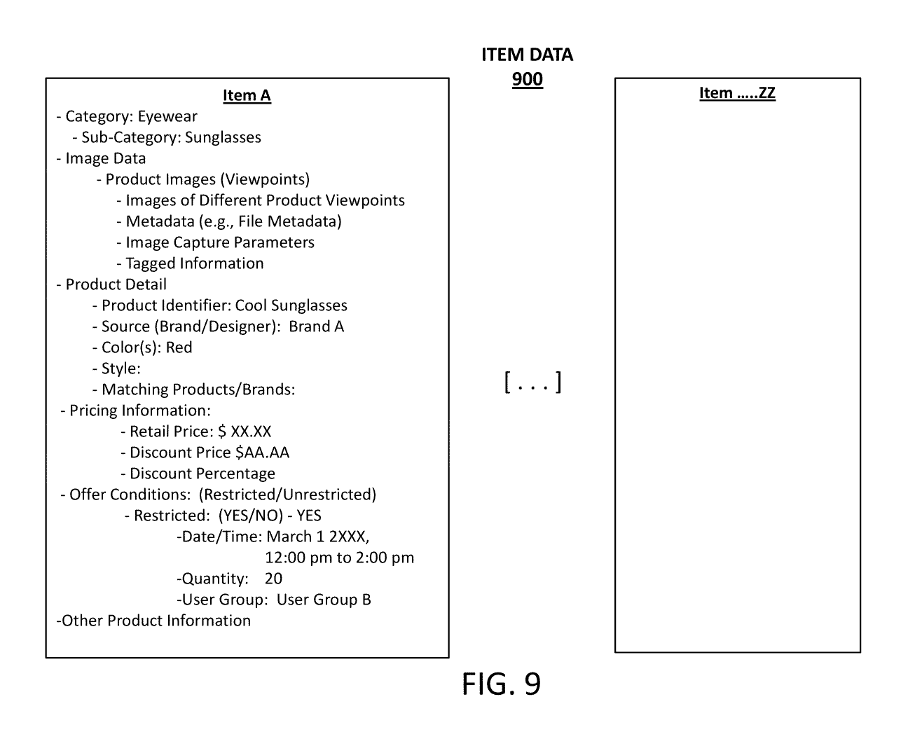

The data storage devices 112, 118, 122 and 132 store data, such as programs and executable code, databases, files and other information, to control an operation of the underlying computer-based device or system to facilitate item sales transactions (online or offline) and to selectively provide flash sales to a user through the user's device (or user device). For example, the data storage devices can store inventory data, flash sales data, sales history of items and user profile data. The inventory data can include item data, such as an item identifier, item images, item description, item pricing information and item offer condition restrictions (e.g., time, quantity, subset of user, etc.) and other item related information for a plurality of items. The flash sales data can include generated or curated flash sales of items, which may be offered to one or more users. Sales history of items can include information reflecting sales performance of items, such as by quantity sold, sales revenue, and/or sales margin in relation to time or number of visits. The user profile data can include user personal information, user preferences, user exposure level to items, personal flash sales for the user (e.g., active, inactive and expired), and other user information to facilitate an item sales transaction. The user exposure level for an item can be expressed quantitatively, such as through a numerical value (e.g., 1, 10, 100, etc.) or qualitatively such as a YES or NO or SMALL, MEDIUM or LARGE, and can include information used to make a quantitative or qualitative exposure level determination such as item transaction history and item browsing history. An example of profile data and item data is described below with reference to FIGS. 8 and 9, respectively.

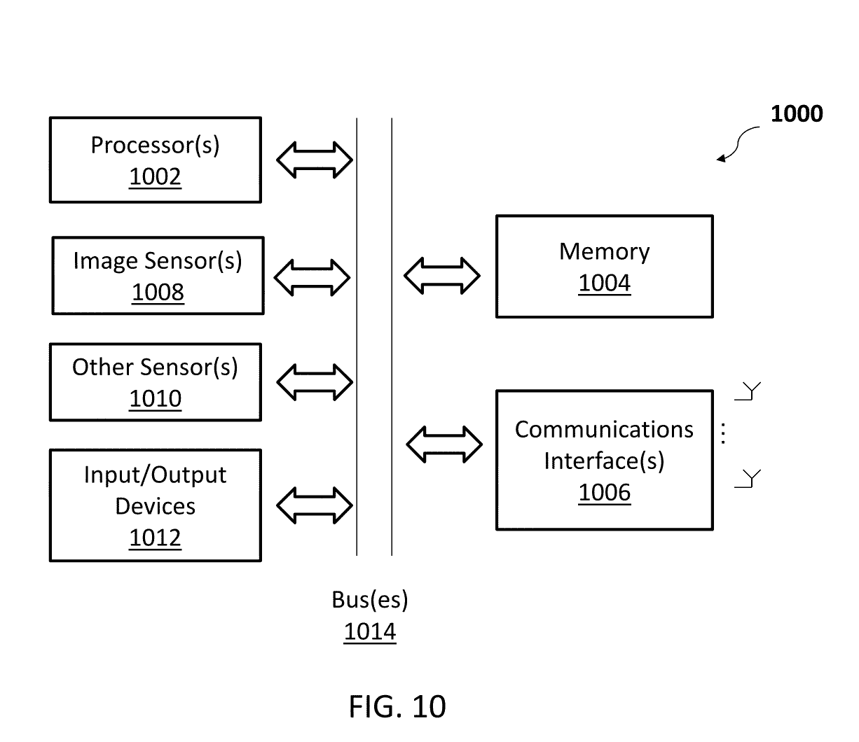

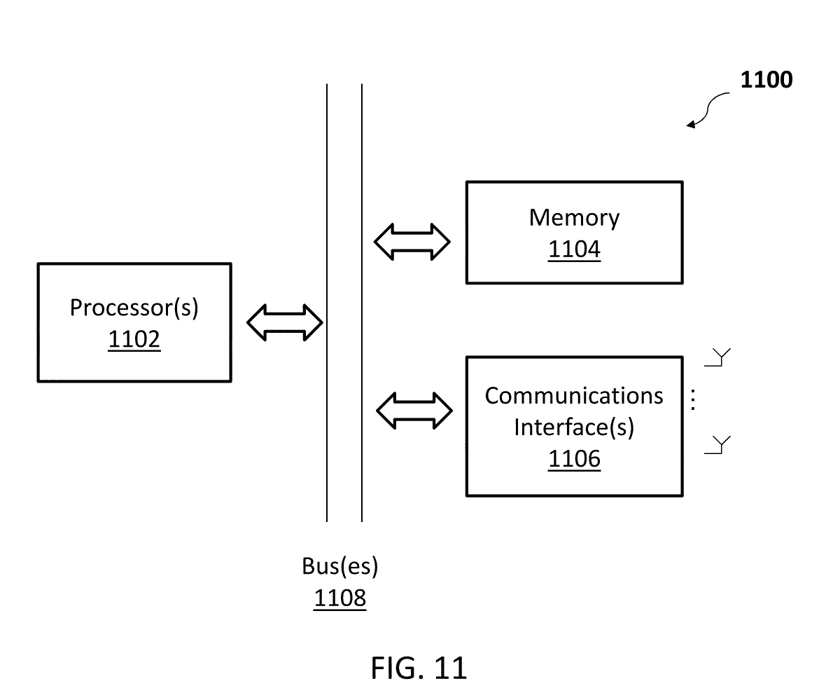

The systems, devices and components of FIG. 1 communicate with each other across a network infrastructure 140, which can include one or more wireless and wire-line networks (public and/or private), and can provide access across the Internet. Exemplary components of user devices 110 and 116 and servers 120 and 130 are described below with reference to FIG. 10 and FIG. 11.

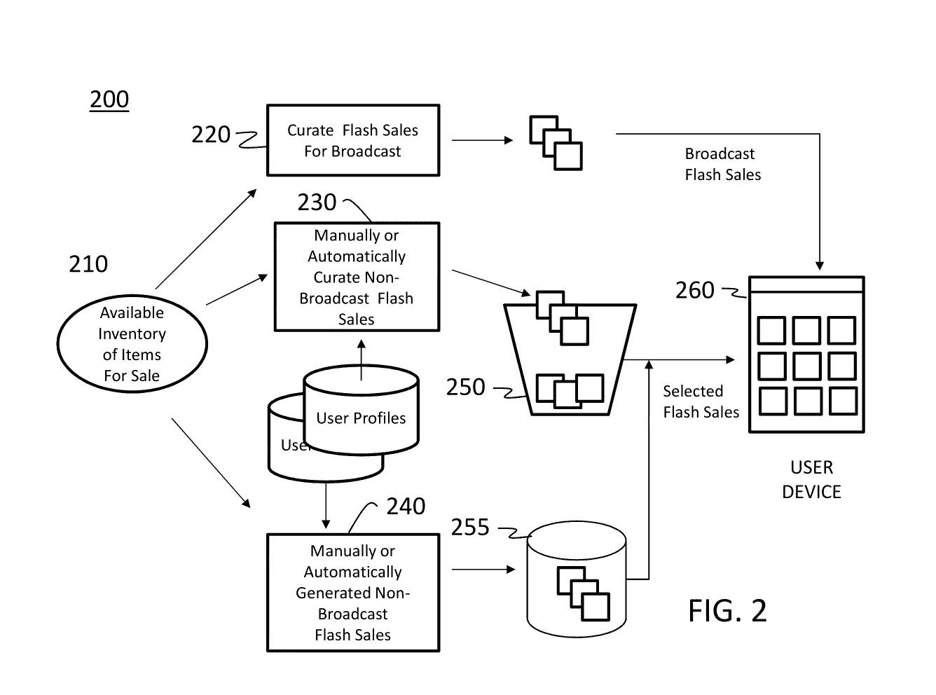

FIG. 2 is an overview of an exemplary process flow for generating, selecting and providing flash sales, including broadcast and non-broadcast flash sales, to a user in accordance with a disclosed embodiment. A broadcast flash sale is a flash sale that is broadcasted or offered concurrently to multiple users, and a non-broadcast flash sale is a flash sale that is not a broadcast flash sale. In this example, at reference 210, an inventory is maintained, which identifies a plurality of items that are available for sale and a quantity of each item available for sale. The inventory is updated to reflect new items and an availability of existing and new items (e.g., sold out or quantity=0 for item Y, quantity=10 of item Z, etc.). At reference 220, flash sales to be broadcasted to a plurality of users or all users (also referred to as “broadcast flash sales”) are automatically or manually generated or curated for items identified in the inventory.

At reference 230, non-broadcast flash sales can be manually or automatically curated with a group of users in mind or a specific theme (e.g., a brand, category, etc.) based a profile of the users, at reference 230. Non-broadcast flash sales may also be generated for a particular user from items in the inventory according to a profile of the user, at reference 240. The user's profile may include user information, user exposure level to items, user preferences, and other information. An example of user profile data is shown in FIG. 8, which is discussed further below. The non-broadcast flash sales are stored in a database(s), from which flash sales may be selected for one or more users. For example, curated non-broadcast flash sales can be stored in a “hopper” database, at reference 250. Generated non-broadcast flash sales can be stored in another database, at reference 255. One or more non-broadcast flash sales from the plurality of non-broadcast flash sales are selected for the user, such as according to user exposure level to items, user preferences (e.g., preferred brands or item categories), sales history of an item and/or other parameters. At reference 260, the broadcasted and selected non-broadcast flash sales are provided to the user's device through which the user can view the provided flash sales and purchase an item, if desired.

Accordingly, the user can be exposed to relevant flash sales of items each and every time the user visits an electronic site (or store), which in turn enhances the user's experience and increases the chance of the site to make a sale or conversion. For example, by selecting and activating flash sales from databases, such as the Hopper database, it is possible to avoid the following situation: a customer visits the site on a day X which offers some flash sales of items to the customer, but finds none of them interesting; however, if the customer would have visited the site the prior day or another day, the customer would have found some interesting flash sales of items.

Furthermore, the non-broadcasted flash sales as discussed herein may include personal flash sales that are generated specifically for the user, flash sales that are curated with a group or theme in mind, flash sales generated by a third party (e.g., item or brand manufacturer) or other flash sales of items. Furthermore, other types of flash sales may also be provided. For example, another type of flash sale is a Bopper flash sale, which is a combination of an expired broadcast flash sale that automatically becomes a Hopper-type flash sale (e.g., placed in the Hopper database) after some conditions are met. For instance, the Bopper flash sale has a broadcast period of X days and then after X days, it will become a Hopper flash sale and will be exposed only to customers who have not been offered or seen the sale before.

In addition, flash sales of items may also be targeted at users on behalf of a third party, e.g., an advertiser. For example, a user may be targeted, manually or automatically, with particular flash sales of items based on various parameters. These parameters can include shopping history of the user, brand affinity, income, geographic location of the user, gender or parameters defined by the third party, or other sales targeting parameters. The third party may be a manufacturer or service provider of items, which pays to have its flash sales or flash sales of its items targeted at users.

### B. Exemplary Processes

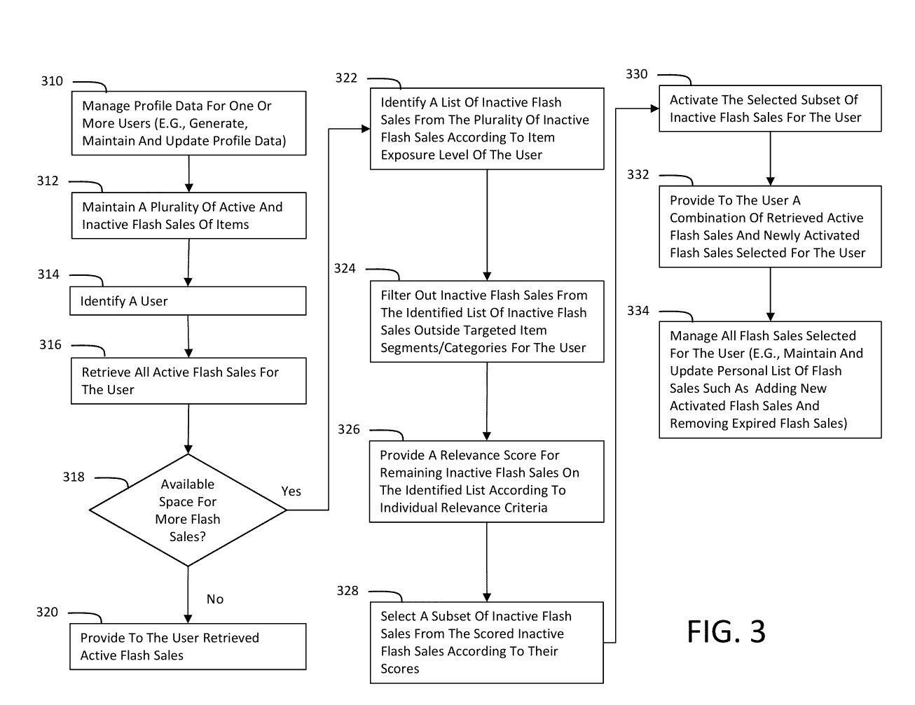

Various exemplary processes are described below with reference to FIGS. 3 through 5, and can be implemented in a system environment, such as shown in FIG. 1. The various processes, or sub-processes, described in these figures and throughout this disclosure are provided as examples of how to generate flash sales, and select and provide flash sales to a user, and may be implemented on the client side (e.g., user device 110 or 116), server side (e.g., servers 120 and 130) or in a distributed manner between the client(s) and the server(s). The operations of each of the processes shown in the figures can also be implemented in a different order or combined, and may include or not include one or more of the operations. Further, the processes described in this disclosure can be implemented by or through an Internet or mobile app.

FIG. 3 is a flow diagram of an exemplary process 300 of providing a personal flash sale experience to a user in accordance with a disclosed embodiment. At reference 310, profile data for one or more users are managed, such as generating, maintaining and updating profile data of one or more users. An example of profile data is shown in FIG. 8. At reference 312, a plurality of active flash sales of items and inactive flash sales of items are maintained in one or more databases. The flash sales may include broadcast flash sales which are flash sales broadcasted or to be broadcasted to a plurality of users, and non-broadcast flash sales. The non-broadcast flash sales can include personal flash sales which are flash sales that are generated or selected for a particular user.

At reference 314, a user is identified. For example, a registered user logs on to the item transaction system, which is configured to offer one or more flash sales to the user. At reference 316, all active flash sales for the user are retrieved. At reference 318, a determination is made whether there is available space for more flash sales, e.g., if more flash sales can be provided to the user. For example, the number of active sales for the user is compared to a maximum flash sales threshold, e.g., fifty (50) flash sales. If no more space is available, the retrieved active flash sales are provided to the user through the user's device, at reference 320. Otherwise, if space is available for more flash sales, a list of inactive flash sales is identified from a plurality of inactive flash sales according to at least the user's exposure level to items associated with the plurality of inactive flash sales, at reference 322. The user's exposure level to an item may, for example, be dependent on a number of times the item was previously offered for sale to the user, or a number of times the item was browsed by the user. Furthermore, a determination can also be made whether to replace an active broadcast flash sale for the user with a proposed flash sale, e.g., such as when the proposed flash sale has a better performance metric (e.g., sells better or more) than the active broadcast flash sale.

The user's exposure level to any particular item or item category may be expressed qualitatively, such as a YES or NO. For example, a user is considered to have been exposed to a particular item if the item was offered for sale to the user based on the browsing history or item transaction history of the user, or other tracked user information (e.g., social media, user questionnaire, etc.). Thus, inactive flash sales of items with an exposure level=YES can be filtered out from the list of inactive flash sales.

The user's exposure level to any particular item or item category can also be expressed quantitatively. For example, no exposure to an item would be reflected with an exposure level=0. Each exposure occurrence to the item is provided a base value, e.g., 25, so five exposure occurrences would result in an exposure level=125. Alternatively, different types of exposure occurrences of an item may also be assigned different values, or weighted differently (e.g., a multiplier). For example, exposure to a non-discounted sales offer for the item (e.g., additional score of 0 or a no weight) may be assigned a smaller value than a discounted sales offer for the item (e.g., additional 25 or a weight of 2). Thus, inactive flash sales of items with an exposure level greater than an exposure level threshold (e.g., 25) are filtered out from the list of inactive flash sales, or in the reverse, less than or equal to exposure level (e.g., 25) are not filtered out.

The exposure level for an item may be determined in advance and stored in the user's profile data, and updated periodically or in response to an event based on tracked user information. Additional examples are discussed below with reference to FIG. 8.

At reference 324, inactive flash sales are further filtered out from the identified list of inactive flash sales if they are outside targeted item segments or categories for the user. For example, particular item segments or categories may be determined to be outside the interest of the user, based on information provided by the user (e.g., user replies to a questionnaire, the user's opt-out of certain item segments or categories, etc.), or a profile of the user (e.g., gender, age, hair color, eye color, ethnicity, location of residence—city, county, state or country, etc.).

At reference 326, a relevance score is determined or provided for the remaining inactive flash sales of items on the identified list according to individual relevance criteria, such as the user's preferences. For example, a score can be calculated based on a number and type of matches between the item offered in the flash sale to the user's preferences (e.g., brand, color, style, price range, model number and/or item category). Each type of user preferences may be assigned a different value (e.g., higher or lower value) or be weighted differently from other types to reflect its importance in determining the user's interest of the item at issue. For example, a brand match has a value of 50 and a style match has a value of 20. An example of the different types of user's preferences is shown and described below with reference to FIG. 8. Furthermore, if desired, sales history of the items may also be used as a selection criteria. For example, flash sales of items with higher performing sales (e.g., higher sales numbers, revenue or margin in relation to time or number of visits) may be selected for activation over those with lower sales performance metrics. Accordingly, the relevance score may also be based on the sales performance, e.g., items with higher performing sales are given higher scores.

At reference 328, a subset of inactive flash sales is selected from the scored inactive flash sales according to their scores. For example, depending on the available space, the inactive flash sales with the top scores are selected. For instance, if there are five available sales spaces, then the first five inactive flash sales with the topmost scores are selected. At reference 330, the selected subset of inactive flash sales is activated for the user. The data for the user, such as the user's profile data is updated accordingly to reflect the activation of new flash sales for the user. At reference 332, a combination of the retrieved active flash sales and the newly activated flash sales selected for the user are provided to the user's device. The selected flash sales may be provided to the user in a manner which makes them indistinguishable from broadcast flash sales. For example, the selected flash sales may be provided in the same sales offer format as broadcast flash sales. Alternatively, the selected flash sales may be purposefully differentiated from broadcast flash sales, by using a different sales offer format than the broadcast flash sales or identifying them as personalized sales offers to the user.

At reference 334, all the flash sales for the user are managed, such as maintaining and updating a personal list of flash sales for the user. The personal list may be updated to add newly activated flash sales and to remove expired flash sales.

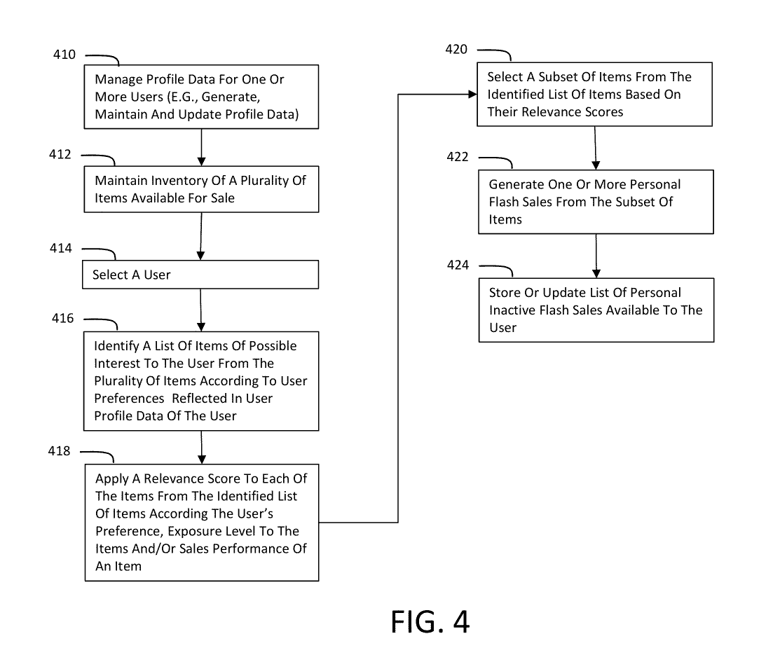

FIG. 4 is a flow diagram of an exemplary process 400 of automatically generating a personal flash sale for a user, in accordance with a disclosed embodiment. At reference 410, profile data is managed for one or more users, such as generating, maintaining and updating profile data for users. The profile data of a user may be generated based on information provided by the user, public information of the user, the user's social media activities and other activities of the user (e.g., purchase or browsing history). An example of profile data is shown in FIG. 8.

At reference 412, an inventory of a plurality of items available for sale is maintained. At reference 414, a user is selected. The user can be selected from a plurality of users registered with the item transaction system. At reference 416, a list of items of possible interest to the user is identified from the plurality of items according to the user's preferences, which may be maintained in profile data for the user.

At reference 418, a relevance score is applied to each of the items from the identified list of items according to the user's preferences, exposure level to the items and/or sales performance of an item (e.g., sales numbers, revenue or margin in relation to time or number of visits). At reference 420, a subset of items is selected from the identified list of items based on their relevance scores. For example, a predefined number (e.g., five) of items with the top scores are selected. At reference 422, one or more personal flash sales are generated from the subset of items. For example, for each item in the subset, a flash sale is automatically created and includes a price for the item, restriction condition (e.g., time limit for the sale as well as other restrictions such as quantity), image(s) of the item and item description.

At reference 424, the list of personal inactive flash sales available to the user are updated according to reflect the newly generated personal flash sales.

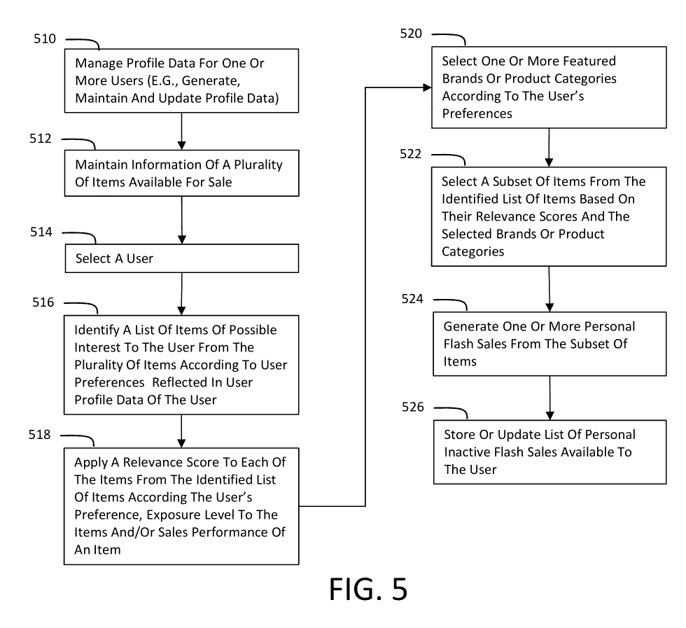

FIG. 5 is a flow diagram of an exemplary process 500 of automatically generating a personal flash sale for a user in accordance with a further disclosed embodiment. At reference 510, profile data is managed for one or more users, such as generating, maintaining and updating profile data for users. The profile data of a user may be generated based on information provided by the user, public information of the user, the user's social media activities and other activities of the user (e.g., purchase or browsing history). An example of profile data is shown in FIG. 8.

At reference 512, an inventory of a plurality of items available for sale is maintained. At reference 514, a user is selected. The user can be selected from a plurality of users registered with the item transaction system. At reference 516, a list of items of possible interest to the user is identified from the plurality of items according to the user's preferences, which may be maintained in profile data for the user.

At reference 518, a relevance score is applied to each of the items from the identified list of items according to the user's preferences, exposure level to the items and/or sales performance of an item (e.g., sales numbers, revenue or margin in relation to time or number of visits). At 520, one or more featured brand or item categories are selected according to the user's preferences.

At reference 522, a subset of items is selected from the identified list of items based on their relevance scores and the selected brands or item categories. For example, a predefined number (e.g., five) of items with the top scores within the selected brands or item categories are selected. At reference 524, one or more personal flash sales are generated from the subset of items. For example, for each item in the subset, a flash sale is automatically created and includes a price for the item, restriction condition (e.g., time limit for the sale or other restrictions such as quantity), image(s) of the item and item description.

At reference 526, the list of personal inactive flash sales available to the user are updated according to reflect the newly generated personal flash sales.

### C. Exemplary Implementations

The following are examples of user interfaces and displays, provided through a user device (e.g., 110 and 116), in which a user receives flash sales of items.

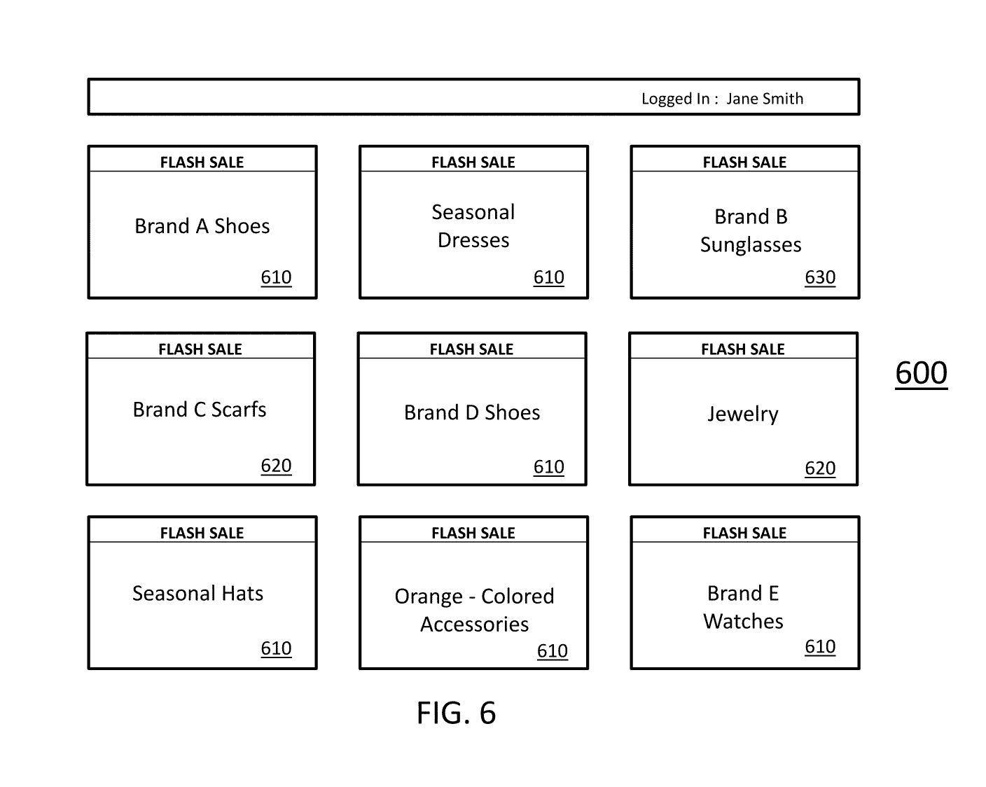

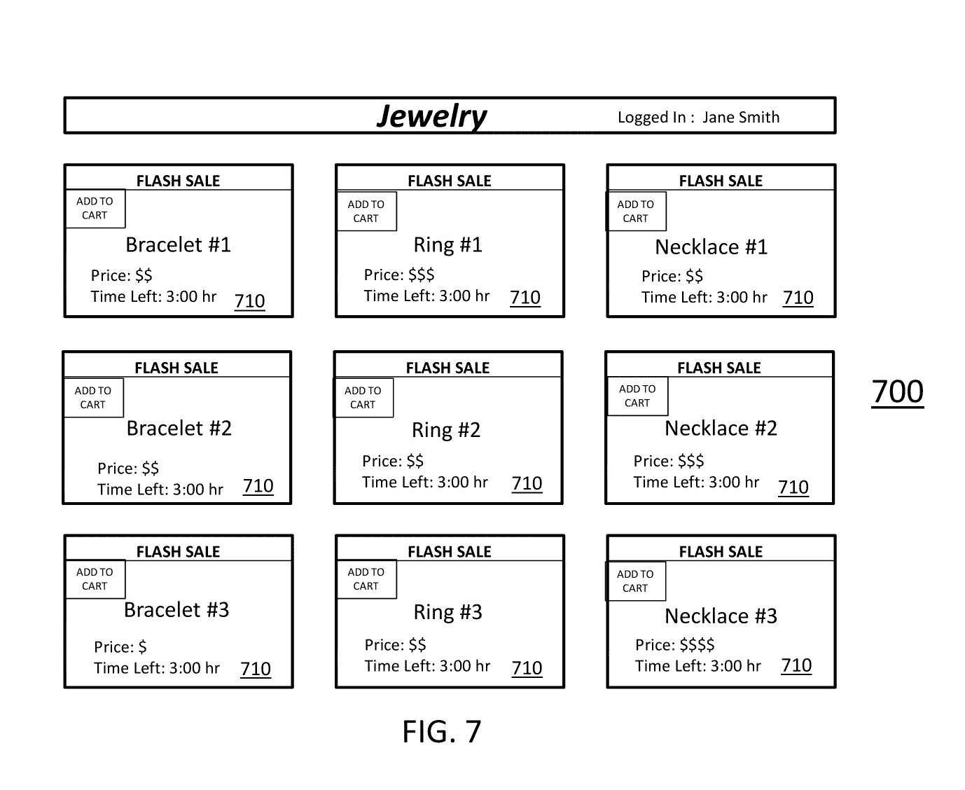

FIGS. 6 and 7 are screenshots of exemplary interfaces 600 and 700, respectively, through which a user is shown a flash sale listing by categories or items offered in accordance with a disclosed embodiment. As shown in FIG. 6, a user (e.g., Jane Smith) is provided with flash sale offerings in a grid layout in various item categories, which include non-broadcast flash sales, such as personal flash sales, selected for the user and broadcast flash sales. The item categories include broadcast flash sale categories 610, personal flash sale categories 620 and merchant flash sales 630. In this example, the broadcast flash sale categories include Brand A shoes, Seasonal Dresses 610, Brand D Shoes, Seasonal Hats and Brand E watches. The personal flash sale categories 620 include Brand C Scarfs and Jewelry. The merchant flash sale category 630 includes Brand B Sunglasses, and includes flash sales of items provided from or presented on behalf of a third party merchant, such as a manufacturer of a certain brand of items, a boutique seller of items or other merchants who wish to offer for sale their items online. The interface 600 may show additional item categories.

FIG. 7 shows personal flash sales offered in the item category of Jewelry of FIG. 6. As shown in FIG. 7, the user interface 700 displays personal flash sales 710, such as for Bracelets, Rings and Necklaces, in a grid layout. In this example, each flash sale may include information such as an item identifier, an item price and a time left for the sale. A user may initiate and complete a purchase transaction of an item, such as by adding an item from one of the flash sales to an electronic cart (e.g., ADD TO CART). Other information may also be included, such as an item image(s) and item description.

### D. Databases

The following are a few exemplary databases for storing and maintaining item and user information, such as item data and user profile data including personal flash sales, in accordance with various embodiments.

FIG. 8 is an exemplary profile data 800 for a user in accordance with an embodiment. As shown in the example of FIG. 8, the profile data 800 includes User Information 810, User Preferences 820 and History 830. The User Information 810 includes personal information such as a User Name, User Contact Information and User Account Information.

The user preferences 820 include preferred brands or designers, preferred color(s), preferred style(s), preferred price range(s), preferred item categories and any other type of user preferences for items. The user preferences 820 may be defined for each item category or item sub-category. For example, the user prefers Brands A and B for shoes. The user may also prefer a particular color (e.g., red) for sunglasses products, a particular style (e.g., contemporary) for furniture products, and a particular price range (e.g., expensive) for shoe products. Further, the user may have food service preferences, such as for a specific food, a food category (e.g., Italian, French, Mexican and Asian) and a restaurant.

The history 830 includes an item transaction history, an item browsing history, and personal flash sale history. The item transaction history can include information on items that have been purchased in the past by the user. This information can include a date of purchase of an item and the item information. The item browsing history can include information on items that the user has viewed in the past, including offers for sale of the items through flash sales or non-flash sales from one or more online merchants. The personal flash sale history can include information on personal flash sales of items previously offered to the user. The information maintained in the history 830 can be used to ascertain an exposure level of the user to particular items, and may also store other miscellaneous item exposure parameters.

The history 830 also can include the user's exposure level to one or more items. The exposure level can be expressed quantitatively (e.g., a numerical value), or qualitatively (e.g., YES or NO, or NONE, SMALL, MEDIUM or LARGE). The user's exposure level to a particular item can be determined by tracking user activities and storing tracked user information, such as maintained in the item transaction history, an item browsing history, and personal flash sale history or other tracked miscellaneous parameters. For example, the user's exposure level to a particular item can be determined based on an occurrence of prior sales offers of the item to the user by tracking the user's activities, including a number of occurrence of sales offer of the item, type of each sales offer of the item (e.g., flash sale, other restrictive sales, regular sale, discounted sale, non-discounted sale), date of each sales offer of the item (e.g., within one day, one week, one month, one year, five years, and so forth), and identity of an online merchant making each sales offer of the item. Each occurrence of a sales offer of the item is given a base value or score, which may be increased or decreased or weighted differently depending on various factors, such as the type of sales offer, date/time of the sales offer, the identity of the online merchant or other factors associated with the sales offer occurrence. Higher exposure values for an item can be assigned to a prior sales offer of the item that is more recent, is discounted, is a flash or restricted sale or is from the same online merchant providing a personal flash sale experience to the user. Lower exposure values for an item can be assigned to a prior sales offer that is not recent, is not discounted, is a regular sale or is from a different online merchant. In general, a user would likely have a greater interest in a flash sale of an item in which the user had little or no prior sales offer exposure.

For example, in one scenario, a user has not been exposed to any sales occurrence of an item T. The user's exposure level to the item T is determined to be a value of zero (0) or NO or NONE. In another scenario, the user is exposed to one sales offer for an item U about a week ago through a sales offer that is a flash sale and is discounted. The exposure level to the item U can be 75, e.g., 25 (Base Value)+25 (Time Period−A week ago)+25 (Discounted). In another scenario, the user is exposed to one sales offer for an item V about 2 years ago through a regular, non-discounted sales offer. The exposure level to the item V can be 25, e.g., 25 (Base Value)+0 (Time Period−Two Years Ago)+0 (Non-Discounted). In a multiple occurrence scenario, the level of exposure could be the cumulative score of each of the sales offer occurrences of the item at issue. A qualitative exposure level may be applied according to the cumulative score (e.g., SMALL<25). Furthermore, the exposure level threshold of the item can be set depending on how much exposure level to the item is acceptable, such as anywhere from Zero (0) or NO or NONE to A Maximum Value or YES or LARGE.

Various techniques can be used to track a user's activities, such as monitoring the user's activities at a server (e.g., 120 and 130) or using tracking cookies or programs on a user device.

As shown in FIG. 8, the user's exposure level to item ZZ is YES or 25. The user's exposure level to an item may be determined or updated from information maintained in the history 830 prior to selection or filtering out of flash sales which may be of interest to the user.

The social media 840 includes information on various social media accounts of the user, such as a Facebook account, a Twitter account and a Google+ account. The information may also include other social media sites that the user frequents. The information maintained on these accounts may also be used to ascertain or update the user's preferences and exposure levels to items.

The active personal flash sales 850 include information relating to one or more currently active personal flash sales offered to the user. As shown in FIG. 8, the active flash sales offered to the user include Sunglasses (Model No. XXXX) at Price $YYYY. The flash sale offer will expire on Jan. 12, 2011 at 12:00 pm. The inactive personal flash sales 860 include information concerning personal flash sales that are yet to be offered to the user. The inactive personal sales may be generated in advance and stored in a database, or generated in real time. The active and inactive flash sales may also have a quantity limitation.

The information maintained or stored in profile data 800 may be used to ascertain a user's exposure level to and preferences for certain items, which in turn are used to provide the user with a personal or selected flash sale(s).

FIG. 9 is an exemplary item data 900 for one or more items (e.g., Item A through Item . . . ZZ) in accordance with a disclosed embodiment. The item data 900 can be used when offering the one or more items for sale to a user, and may be maintained as part of inventory data for use in generating flash sales or other sales offers.

As shown in FIG. 9, the item data of each item can include a category and subcategory of the item, image data, item detail, pricing information, offer conditions and other item information. The image data includes product image(s) and description tag of the image data. The item detail includes an item identifier, source (brand/designer), color(s), style(s) and other matching products/brands.

The pricing information includes any information about the price and pricing of the item, such as a retail price, a discount price and a discount percentage. The offer conditions define the conditions under which the item may be offered for sale, and can be restricted or unrestricted. In this example, the offer conditions include restricted and unrestricted conditions. The restricted conditions may limit a sale of the product to particular time duration (e.g., a date and time or a time period) as well as to a particular quantity and/or to a particular user group.

### Exemplary Personal Flash Sale Scenario

An example of a personal flash sale scenario is provided for the purposes of explanation. For example, a user through his or her user device establishes communication (e.g., a connection) with an item transaction system operated by an online merchant. The item transaction system selects and activates one or more non-broadcast flash sales, such as personal flash sales only for the user, and provides them to the user's device along with activated broadcast flash sales which are offered to a plurality of users or all users. The personal flash sales may be offered to the user in a manner, which is indistinguishable from broadcast flash sales or other flash sales (e.g., in the same format). As a consequence, the user is provided with a personal flash sale experience, which can be based on the user's exposure level to items, the user's preferences and sales history of the items.

### E. Exemplary Components

FIG. 10 illustrates a block diagram of exemplary components of a user device 1000, such as in FIG. 1 (e.g., 110 and 116), in accordance with a disclosed embodiment. The device 1000 includes processor(s) (or controllers) 1002, memory 1004, communications interface(s) 1006, image sensor(s) 1008, other sensor(s) 1010, input/output device(s) 1012, and bus(es) 1014 for interconnecting components of the device.

The memory 1004 can be a non-transitory computer-readable storage medium used to store executable instructions (or codes) or computer programs thereon or to store other data. The memory 1004 may include a read-only memory (ROM), random access memory (RAM), programmable read-only memory (PROM), erasable programmable read-only memory (EPROM), a hard drive, a solid state drive, secure digital (SD) or micro SD card, a smart card, a subscriber identity module (SIM), or any other medium from which a computing device can read executable instructions or a computer program or data. The term “computer program” is intended to encompass an executable program (or codes) that exists permanently or temporarily on any computer-readable storage medium as described above.

The computer program also includes an algorithm that includes executable instructions stored in the memory 1004 that are executable by the processor(s) 1002, which may be facilitated by one or more of the application programs also stored on the memory 1004. The application programs may also include, but are not limited to, an operating system or any special computer program that manages the relationship between application software and any suitable variety of hardware that helps to make-up a computer system or computing environment of device 1000. For example, the computer program may also include a browser, an email program, and applications (or apps), including mobile and internet apps. One or more of the applications may be for receiving and viewing sales offers of items (e.g., goods and/or services) and purchasing items, as discussed in this disclosure.

The communications interface(s) 1006 include transmit and receive circuitry (or components) for conducting wireless or line-based communications with a network or network node, or other communications-enabled devices. For example, the communications interface(s) can include line-based interface(s), and one or more transmit antennas and one or more receive antennas for conducting wireless communications.

The image sensor(s) includes one or more cameras for capturing still or video images. A camera can be positioned on a front of the user device and/or on the back of the user device. The other sensor(s) 1010 include a position sensor, touch sensor or touch screen, audio sensor, accelerometer, inclinometer, compass and gyro meter or other device for sensing characteristics, such as the environment of the device or the user. These other sensors (including the image sensors) can be used to ascertain user inputs (or commands), such as user gestures.

The input/output device(s) 1010 may include various input and output devices. For example, the input devices may include a touch input device (e.g., a keyboard, mouse, buttons, switches, touch display or screen, touchpad), audio input (e.g., a microphone), or a device that enables that user to provide information through some other medium. For example, the sensors can be used to sense user input (e.g., user motions or gestures). The output devices may include a visual output device (e.g., a display), an audio output device (e.g., speaker), a vibrational output device or a device that provides information to a user through some other medium.

FIG. 11 illustrates a block diagram of exemplary components of a server 1100, such as in FIG. 1 (e.g., 120 and 130), in accordance with an embodiment. The server 1100 includes processor(s) (or controllers) 1102, memory 1104, communications interface(s) 1106, and bus(es) 1108 for interconnecting components of the network node.

The memory 1104 can be a non-transitory computer-readable storage medium used to store executable instructions (or codes) or computer program or to store other data. The memory 1104 may include a read-only memory (ROM), random access memory (RAM), programmable read-only memory (PROM), erasable programmable read-only memory (EPROM), a smart card, a hard drive, a solid state drive, or any other medium from which a computing device can read executable instructions or a computer program or data. The term “computer program” is intended to encompass an executable program that exists permanently or temporarily on any computer-readable storage medium as described above.

The computer program also includes an algorithm that includes executable instructions stored in the memory 1104 that are executable by the processor(s) 1102, which may be facilitated by one or more of the application programs also stored on the memory 1104. The application programs may also include, but are not limited to, an operating system or any special computer program that manages the relationship between application software and any suitable variety of hardware that helps to make-up a computer system or computing environment of server 1100. For example, the computer program also includes programs and codes to implement the various processes discussed in the present disclosure.

The communications interface(s) 1106 include transmit and receive circuitry (or components) for conducting wireless or line-based communications with a device. For example, the communications interface(s) can include line-based interface(s) such as for conducting communications with other network components, and one or more transmit antennas and one or more receive antennas for conducting wireless communications.

The various apparatus, methods, flow diagrams, and structure block diagrams described in this disclosure may be implemented in a computer processing system including program code comprising program instructions that are executable by the computer processing system. Other implementations may also be used. Further, the flow diagrams and structure block diagrams described in the present disclosure, which describe particular methods and/or corresponding acts in support of steps and corresponding functions in support of disclosed structural means, may also be utilized to implement corresponding software structures and algorithms, and equivalents thereof.

The various exemplary embodiments described in this disclosure can be implemented as one or more computer program products, i.e., one or more modules of computer program instructions encoded on a tangible program carrier for execution by, or to control the operation of, a user device or server. The computer readable medium can be a machine readable storage device, a machine readable storage substrate, a memory device, a composition of matter effecting a machine readable propagated signal, or a combination of one or more of them.

A computer program (also referred to as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by a processing system. For example, one or more programmable processors or digital signal processors (DSPs) can execute one or more computer programs to perform functions by operating on input data and generating output. The processes and logic flows can also be performed by special purpose logic circuitry, e.g., an FPGA (field programmable gate array) or an ASIC (application specific integrated circuit) or CPLD (Complex Programmable Logic Device), or a combination of various processors and special purpose logic circuitry.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, optical disks or solid-state drives. However, a computer need not have such devices.

To provide for interaction with a user, the disclosed embodiments can be implemented on a computer or computing device (e.g., user devices 110 and 116 in FIG. 1) having a display device, e.g., a CRT (cathode ray tube) or LCD (liquid crystal display) monitor, for displaying information to the user and a keyboard, touch screen and a pointing device (e.g., a mouse or a trackball) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, motion or tactile input.

The disclosed embodiments can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. The computing system can include clients and servers. A client and server are generally remote from each other and typically interact through a communication network. The relationship of client and server arises by virtue of computer programs running on the respective computers and having a client server relationship to each other.

While this disclosure contains many exemplary implementations, they should not be construed as limitations on the scope of any invention or of what may be claimed, but rather as descriptions of features that may be specific to particular embodiments of particular inventions. Certain features that are described in this disclosure in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the disclosed embodiments should not be understood as requiring such separation in all embodiments, and it should be understood that the described program components and systems can generally be integrated together in a single software product or packaged into multiple software products.

1. A computer-implemented method comprising:
maintaining a plurality of flash sales of items including inactive flash sales and flash sales to be broadcasted to a plurality of users;
selecting for a user one or more inactive flash sales from the plurality of flash sales of items according to a user's exposure level to items;
activating the selected one or more flash sales; and
providing to a user a combination of flash sales including the broadcasted flash sales and the selected one or more flash sales.

2. The computer-implemented method according to claim 1, further comprising: tracking an exposure level to one or more items by the user.

3. The computer-implemented method according to claim 2, wherein the exposure level of the user to an item comprises one of a number of times the item was previously offered for sale to the user or a number of times the item was browsed by the user.

4. The computer-implemented method according to claim 1, wherein the selected one or more flash sales include one or more personal flash sales of items for the user, the method further comprising:
selecting one or more items available for sale according to preferences of the user, a sales performance of the one or more items or the user's exposure level to the one or more items; and
automatically generating one or more personal flash sales with the selected one or more items.

5. The computer-implemented method according to claim 4, wherein the preferences of the user comprises one of brand preference or item category preference.

6. The computer-implemented method according to claim 1, wherein the one or more inactive flash sales of items are selected according to an exposure level to the items by the user and at least one of a sales history of an item or a user preference.

7. The computer-implemented method according to claim 1, further comprising: updating a personal list of activated flash sales for the user to include the activated, selected one or more flash sales.

8. The computer-implemented method according to claim 7, further comprising: updating the personal list of activated flash sales for the user to remove expired flash sales.

9. The computer-implemented method according to claim 8, further comprising: retrieving and providing activated flash sales to the user from the personal list of activated flash sales in response to detection of a logon by the user.

10. A device comprising:
memory; and
one or more processors, coupled to the memory, for:
maintaining a plurality of flash sales of items including inactive flash sales and flash sales to be broadcasted to a plurality of users;
selecting for a user one or more inactive flash sales from the plurality of flash sales of items according to a user's exposure level to items;
activating the selected one or more flash sales; and
providing to a user a combination of flash sales including the broadcasted flash sales and the selected one or more flash sales.

11. The device according to claim 10, wherein the one or more processors are further configured to track an exposure level to one or more items by the user.

12. The device according to claim 11, wherein the exposure level of the user to an item comprises one of a number of times the item was previously offered for sale to the user or a number of times the item was browsed by the user.

13. The device according to claim 10, wherein the selected one or more flash sales include one or more personal flash sales of items for the user, the one or more processors being further configured to:
select one or more items available for sale according to preferences of the user, a sales performance of the one or more items or the user's exposure level to the one or more items; and
automatically generate one or more personal flash sales with the selected one or more items.

14. The device according to claim 13, wherein the preferences of the user comprises one of brand preference or item category preference.

15. The device according to claim 10, wherein the one or more inactive flash sales of items are selected according to an exposure level to the items by the user and at least one of a sales history of an item or a user preference.

16. The device according to claim 10, wherein the one or more processors are further configured to update a personal list of activated flash sales for the user to include the activated, selected one or more flash sales.

17. The device according to claim 16, wherein the one or more processors are further configured to update the personal list of activated flash sales for the user to remove expired flash sales.

18. The device according to claim 17, wherein the one or more processors are further configured to retrieve and provide activated flash sales to the user from the personal list of activated flash sales in response to detection of a logon by the user.

19. A non-transitory computer readable medium storing executable code, which when executed by one or more processors, implements the computer-implemented method comprising:
maintaining a plurality of flash sales of items including inactive flash sales and flash sales to be broadcasted to a plurality of users;
selecting for a user one or more inactive flash sales from the plurality of flash sales of items according to a user's exposure level to items;
activating the selected one or more flash sales; and
providing to a user a combination of flash sales including the broadcasted flash sales and the selected one or more flash sales.
